(19) United States
(12) Patent Application Publication
(10) Pub. No.: US 2010/0318257 A1
(43) Pub. Date: Dec. 16, 2010

(54) METHOD AND SYSTEM FOR AUTOMATICALLY CALIBRATING A THREE-AXIS ACCELEROMETER DEVICE

(76) Inventor: Deep Kalinadhabhotla, Atlanta, GA (US)

Correspondence Address: HUGHES TELEMATICS, INC., 2002 Summit Blvd, Suite 1800, ATLANTA, GA, 30319, US

(21) Appl. No.: 12/816,350

(22) Filed: Jun. 15, 2010

Related U.S. Application Data
(60) Provisional application No. 61/187,019, filed on Jun. 15, 2009.
(60) Provisional application No. 61/229,196, filed on Jul. 28, 2009.

(51) Int. Cl. G06F 7/00; G01P 21/00; G06F 19/00

(52) U.S. Cl. 701/29; 702/104

(57) ABSTRACT

A method calculates Euler's rotation angles used to transform sampled values from a referred coordinate frame of a three-axis accelerometer device fixed to a vehicle to a reference coordinate frame of the vehicle. The method determines two rotation angles while the vehicle is still and assumed not inclined with respect to gravity, so that only the transformed value corresponding to a vertical axis of the vehicle equals acceleration due to gravity. Then, data acquired from the sensors typically during a braking event and indicated by a vehicle diagnostic system, along with the other two rotation angles, are used in the first derivative of a second Euler's rotation equation to determine the remaining rotation angle. Data from the sensors is transformed by the three angles to the vehicle's coordinate frame and correlated with acceleration data derived from the diagnostic system to verify the rotation angles.

### CROSS REFERENCE TO RELATED APPLICATIONS

This application claims priority under 35 USC sec. 119 to US Provisional Patent Applications 61/187,019 and 61/229,196; having filing dates of Jun. 15, 2009, and Jul. 28, 2009, respectively, and this application incorporates them herein in their entireties.

### SUMMARY

A device used in a vehicle that acquires and wirelessly transmits vehicle performance data may use multiple accelerometer sensors to determine acceleration of the vehicle. The accelerometers typically determine acceleration along three orthogonal axes. Thus, the device can output signal values—typically digital representations of analog signals—that represent acceleration along the three axes.

If a device having multiple accelerometer sensors, such as, for example, an off-the-shelf integrated circuit having three accelerometers, is fixed to a vehicle so that the axes the accelerometer sensors measure force along align with the axes of the vehicle, then a computer receiving the output of can use the output digital representations directly.

If the same off-the-shelf device is used in a device fixed in a vehicle, then filtering applied to the outputs of the accelerometer integrated circuit can help mathematically rotate the axes of the accelerometer to align with the axes of the vehicle.

Such a scenario may arise when a consumer installs a device by connecting it to an on board diagnostic connection, such as, for example, an OBDII port, and then causally places the device on the vehicle's dash board without regard for alignment with respect to the vehicle.

A software method running on the device can automatically determine three rotation angles corresponding to the angles that the three axes of the device deviate from the respective axes of the vehicle. As a matter of convention, this application assumes that the ‘z’ axis is parallel with gravity, the ‘y’ axis is parallel with straight, forward motion (longitudinal) of the vehicle, and the ‘x’ axis is orthogonal to both the z and y axes, and points to the right of the vehicle. Essentially, the vehicle reference axes follow the ‘right-hand-rule’ for purposes of direction and relation to each other.

The software running on the device can determine whether the vehicle is still (i.e., motionless) by evaluating signals from a GPS portion and from the OBDII port. If the vehicle is still, and the device is stationary with respect to the vehicle, the only acceleration affecting the device is due to gravity. Thus, the software resolves two angles so that the z-axis of the device aligns with the reference z axis. Determining these two angles involves determining a first angle, which then virtually rotates the axis of the device so that it's z axis lies in one of the planes formed by either of the z-x or z-y planes. Then the second angle is determined based on the newly rotated axes of the device so that the z axis of the device aligns with the z axis of the vehicle (z axis is deemed parallel with gravity).

Then, after these first two angles have been determined, the device software can detect acceleration from a signal representing speed from the OBDII port. Having determined and stored the first two angles, the device software uses forward-motion acceleration using a speed signal from the OBDII port to determine the skew angle of the device's y-axis with respect to the y-axis of the vehicle. The device software uses course information from a signal from the GPS to determine that that vehicle is traveling straight, rather than turning.

### BRIEF DESCRIPTION OF THE DRAWINGS

FIG. 1 illustrates Euler's rotations that transform a first coordinate frame into a second coordinate frame.

FIG. 2, illustrates a vehicle with an accelerometer device fixed to it, and reference and referred coordinate frames, respectively.

FIG. 3 illustrates a flow diagram of a method for determining second and third rotation angles.

FIG. 4 illustrates a flow diagram of a method for determining a first rotation angle.

FIG. 5 illustrates a flow diagram of a method for determining a longitudinal acceleration using three rotation angles.

FIG. 6, illustrates a flow diagram of a method for correlating measured acceleration values with acceleration values derived from data from a diagnostic system.

### DETAILED DESCRIPTION

As a preliminary matter, it will be readily understood by those persons skilled in the art that the present aspects are susceptible of broad utility and application. Many methods, embodiments, aspects, and adaptations other than those herein described, as well as many variations, modifications, and equivalent arrangements, will be apparent from or reasonably suggested without departing from the substance or scope described herein.

Accordingly, while a detailed description in relation to preferred embodiments has been given, it is to be understood that this disclosure is only illustrative and exemplary and is made merely for the purposes of providing a full and enabling disclosure. The following disclosure is not intended nor is to be construed to limit or to exclude other embodiments, adaptations, variations, modifications and equivalent arrangements, the present invention being limited only by the claims appended hereto and the equivalents thereof.

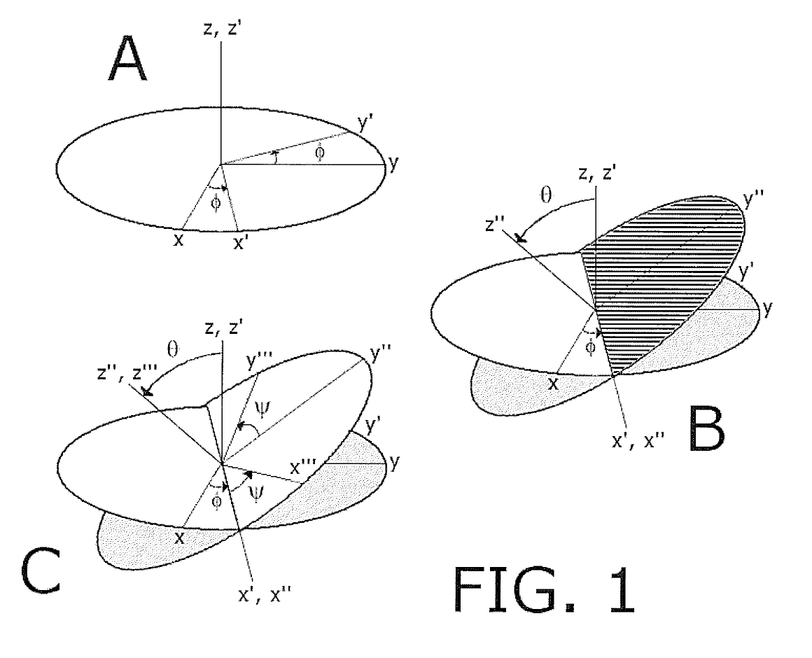

FIG. 1 illustrates the three Euler's rotations that transform a coordinate, a set of coordinates, or a vector, in a first coordinate frame into a corresponding coordinate, set of coordinates, or a vector in a second coordinate frame. In the preferred embodiment, the z-axis is selected as the first axis to rotate about. Choosing the z-axis as the first axis simplifies the determination of Euler's angles needed to transform from a first coordinate frame to a second coordinate frame. This is because the z-axis, in a three-axis coordinate frame system, is chosen parallel to force exerted by gravity.

After determining three new axes, a rotation about the new x-axis, or is performed, and three new axes, x″, y″, and z″ result. After performing the rotation about x′, a third rotation is performed about z″. Performing these Euler rotations results in three new axes, x′″, y′″, and x′″, and three Euler angles. The three axes x, y, and z compose a reference coordinate frame, and the original coordinate frame x′″, y′″, and z′″ compose the referred frame. Applying the three Euler's rotation angles to points, lines, vectors, sectors, and shapes described in the referred frame ‘refer’ them to corresponding points, lines, vectors, sectors, and shapes in the reference frame. Therefore, determining the three Euler rotation angles for transforming, or rotating, vectors from an accelerometer device's referred coordinate frame to the reference coordinate frame of a vehicle in which the accelerometer device has been installed, transforms, or rotates, acceleration vectors (vectors representing acceleration forces experienced by the sensors of a three-axis accelerometer) from the referred frame to the reference frame. Accordingly, even if an installer, or consumer, install a three-axis accelerometer device into a vehicle such that the axes of the referred coordinate frame are not parallel with corresponding axes of the reference coordinate frame, applying the Euler angles to signals output from the accelerometer device can result in transforming the signal values from the accelerometer to signal values that indicate acceleration experienced by the vehicle.

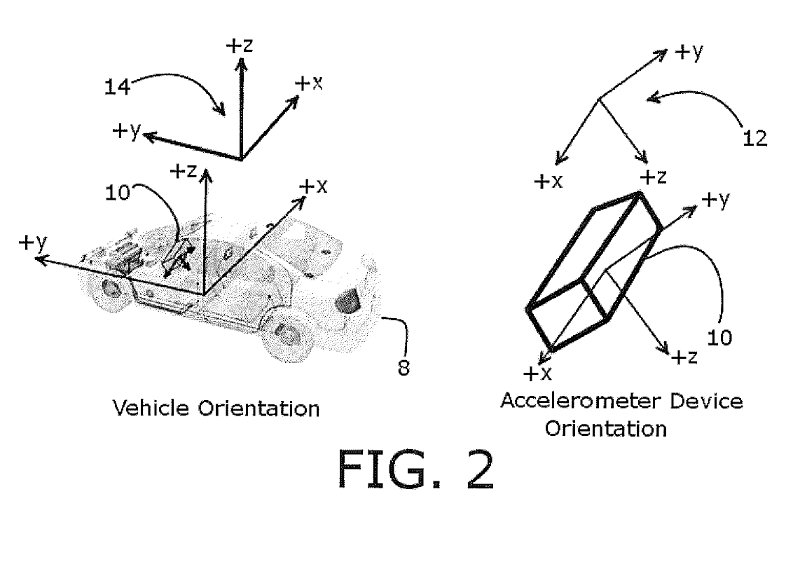

Turning now to FIG. 2, the figure illustrates a vehicle 8 with an accelerometer device 10 fixed to it. A referred coordinate frame 12 corresponds to accelerometer device 10 and reference coordinate frame 14 corresponds to vehicle 8. As used herein, reference coordinate frame, reference frame, vehicle frame, and vehicle coordinate frame may be used interchangeably. Likewise, as used herein, referred coordinate frame, referred frame, accelerometer device frame, and accelerometer device coordinate frame may be used interchangeably. The axes of reference coordinate frame 12 align with the vehicle, according to the convention that z is in the direction of force opposing gravity, y is in the direction of force propelling vehicle 10 forward, and x is in the direction of force pushing the vehicle in the direction of the passenger side (as used in reference to vehicles made for use in the United States with the steering wheel on the left side of the passenger compartment).

Accelerometer device 10 may be part of a telematics control unit, that includes wireless communications circuitry, such as, for example, cellular telephony circuitry, global positioning satellite circuitry (“GPS”), and other circuitry for processing data and information, interfacing with graphical, haptic, tactile, and audio interfaces. Using the wireless communications circuitry, accelerometer device 10 may wirelessly transmit acceleration values corresponding to the three axes of the vehicle frame to a central computer over a wireless communications networks and internetwork.

In addition to wireless circuitry, GPS, interface drivers and processors, accelerometer device 10 may also be coupled to a diagnostic, vehicle performance, and maintenance port, such as, for example, an On Board Diagnostics II (“OBD-II) port. Acceleration device 10 may be configured to retrieve data and information from the vehicle through the OBD port. Such information may include vehicle speed data, brake application information, throttle position information, steering wheel angle information, and information and data related to other performance and operational parameters of the vehicle.

Alternatively, accelerometer device 10 may include circuitry for communicating with the vehicle's diagnostic system via an OBD connector and short range wireless circuitry, such as Bluetooth transceiver circuitry, for communicating accelerometer data to a processing device, such as a smart phone or central computer. The processing device could include a wireless data transceiver circuit that could perform the methods described herein instead of the is accelerometer device 10 being configured to perform these methods.

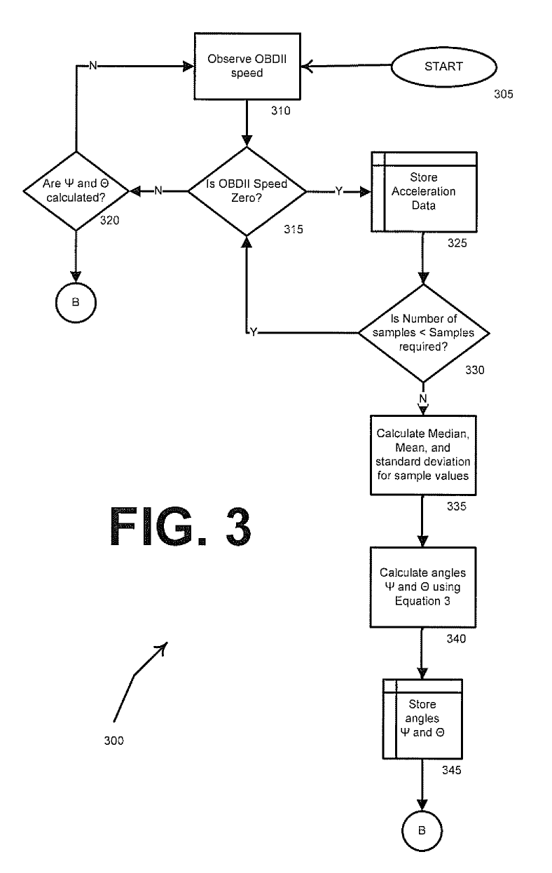

Turning now to FIG. 3, the figure illustrates a flow diagram of a method 300 that begins at step 305. For the purposes of the following discussion of the preferred embodiment, method 300 may be embodied in software code running on accelerometer device 10, as referenced in FIG. 2. However, method 300, and other methods described herein that interact with method 300, could also be software code running on a central computer, or computer device remote from accelerometer device 10. For example, accelerometer device 10 may transmit vehicle data to a central computer that performs rotations and calculations of acceleration from signals received from the accelerometer device. Also, method 300, and other methods described here, could run on a mobile wireless device, such as, for example, a smart phone, that receives data from acceleration device 10 via a wired, or wireless link, such as a short range wireless link like BlueTooth.

Returning to discussion of FIG. 3, after beginning, method 300, causes the accelerometer device to monitor vehicle speed at step 310 from determined from a signal generated according to a protocol (e.g., J2284, ISO15765, or equivalents) received from the vehicle's onboard computer/diagnostic system. Typically, the accelerometer device receives the vehicle speed data through an OBD-II connector, or equivalent.

One will appreciate that method 300 does not always perform all its steps. Typically, after an accelerometer device first operates, method 300 performs its steps three times, although this number of iterations may be altered, or may be periodic if a user or entity contracting with the user wishes to use more processor resources to perform the steps regularly.

One of the reasons that it is not desirable based on current processor performance and technology is that at step 315, method 300 determines whether the vehicle that the accelerometer device is fixed in is stationary. If method 300 operated continuously, it would perform steps following step 315 every time a given vehicle came to a stop. Not only would this use resources of the processor performing method 300, but data generated by method 300 and its related methods, which will be discussed in detail herein in reference to other figures, may have reduced value because the end result of the methods described herein is to determine scalar values to multiply signals values output from the accelerometer device. If these scalar values change every time a vehicle stops, comparison of acceleration values from different trips, or even different trip segments might not provide useful results inasmuch as they might not have a common factor relating them.

Returning to the discussion of step 315, if method 300 determines that vehicle 8 (shown in FIG. 2) producing data through the OBD-II connector is moving (vehicle speed information from the OBD-II connector indicates speed not zero) the method advances to step 320, where a determination is made whether second and third Euler rotation angles have been determined.

The designation of second and third angles is used because these are the angles determined following the second and third rotations of the axis as shown in FIG. 1. The second rotation is show in FIG. 1B, which shows the result of FIG. 1A rotated about the x′ axis (this is also the x″ axis). The third rotation angle is shown in FIG. 1C, which shows the resultant coordinate frame from FIG. 1B rotated about the z″ axis. The second rotation angle θ results from the rotation in FIG. 1B, and the third rotation angle Ψ results from the third rotation shown in is FIG. 1C. The first angle of rotation as shown in FIG. 1A is φ, which method 300 determines by rotating the reference angle about the z axis. Thus, the designation as first, second, and third angles, for φ, θ, and Ψ track the mathematical process used in performing the algebraic operations on equation 1 for determining matrixes and solving for them to arrive at equation 2 below. Vector C is the acceleration vector in the reference frame, and vector A is the acceleration vector in the referred frame. In eq.1, ‘R_{zpp}’, ‘Rₓₚ’, and ‘R_{z}’ refer to standard Euler's rotation matrices when the first rotation is performed about the z axis.

$$\begin{matrix}\vec{C} = {R}_{zpp} ( ψ ) \cdot {R}_{xp} ( θ ) \cdot {R}_{z} ( ϕ ) \cdot \vec{A} & eq . 1 \\ ( \begin{matrix}{C}_{x} \\ {C}_{y} \\ {C}_{z}\end{matrix} ) = ( \begin{matrix}cos ( ϕ ) \cdot cos ( ψ ) - cos ( θ ) \cdot sin ( ϕ ) \cdot sin ( ψ ) \\ cos ( ψ ) \cdot sin ( ϕ ) + cos ( ϕ ) \cdot cos ( θ ) \cdot sin ( ψ ) \\ sin ( ψ ) \cdot sin ( θ )\end{matrix} ) \cdot ( \begin{matrix}{A}_{x} \\ {A}_{y} \\ {A}_{z}\end{matrix} ) & eq . 2\end{matrix}$$

However, typically, as recited in some of the Claims below, method 300 determines an actual value for φ after determining the actual values for the second and third rotation angles using acceleration due to gravitational force while the vehicle is still to determine actual values for θ and Ψ, but uses longitudinal acceleration while the vehicle is moving in a substantially forward direction to determine an actual value of φ after having already determined actual values for the other two angles. When the vehicle is still, only gravity acts on the vehicle. By performing method 300 a predetermined number of times (three times in the preferred embodiment) after placing an accelerometer device into service, or after angle values stored in the devices memory have been reset, as will be discussed below in reference to another figure, the method averages the angle values determined by method 300 to minimize inaccuracies that may occur if the vehicle is not on a substantially flat surface when determining actual values for the second and third rotation angles θ and Ψ. However, method 300 may be performed any number of times, including one.

After determining that the vehicle's speed is zero, method 300 advances to step 325 and samples and stores values from each of three sensors aligned with a corresponding axis of the referred plane. The values being stored at step 325 include raw data, typically voltage/magnitude values from a sensor. In an aspect, method 300 sorts the samples as they arrive from the sensor to reduce processor time as compared to sorting all samples at once after they have all been acquired.

After storing the actual values for the angles to memory, method 300 determines at step 330 whether the number of samples of sensor acceleration data is higher than a predetermined number of samples, which can be referred to as a sample window. In an aspect, the sample window is ten seconds and the sample rate is twenty-seven samples per second, for a total of 270 samples. If the number of samples is not higher than the predetermined number, then method 300 returns to step 315 and continues sampling data until the predetermined number of samples has been acquired. If method 300 determines at step 330 that the predetermined number has of samples have been acquired, it advances to step 335 and calculates and stores a median acceleration value for the sensors' values sampled during the sample window. If the sampled data was sorted as it arrived as described above, method 300 would need only to use the 135^{th} sample, for example, as the median. If the data samples are not sorted as they arrive, then method 300 sorts them before calculating the median. Method 300 also calculates a mean value and a standard deviation value at step 335 for the data sampled for each of the accelerometer sensors during the sample window.

is At step 340, method 300 calculates actual values for θ and Ψ using the median calculated at step 335 in equation 3 given below, and stores the calculated/actual values of these second and third rotation angles to memory at step 345. Typically the memory includes a memory of the accelerometer device, but could be a memory of another computer or device such as a central computer or a smart phone. After performing step 345, method 300 ends and control of the device that performed it passes to method 400.

$$θ = {tan}^{- 1} [ \frac{\sqrt{( {A}_{X}^{2} + {A}_{Y}^{2} )}}{{A}_{Z}} ] \\ ψ = {tan}^{- 1} ( \frac{{A}_{X}}{{A}_{Y}} ) . \qquad eq . 3$$

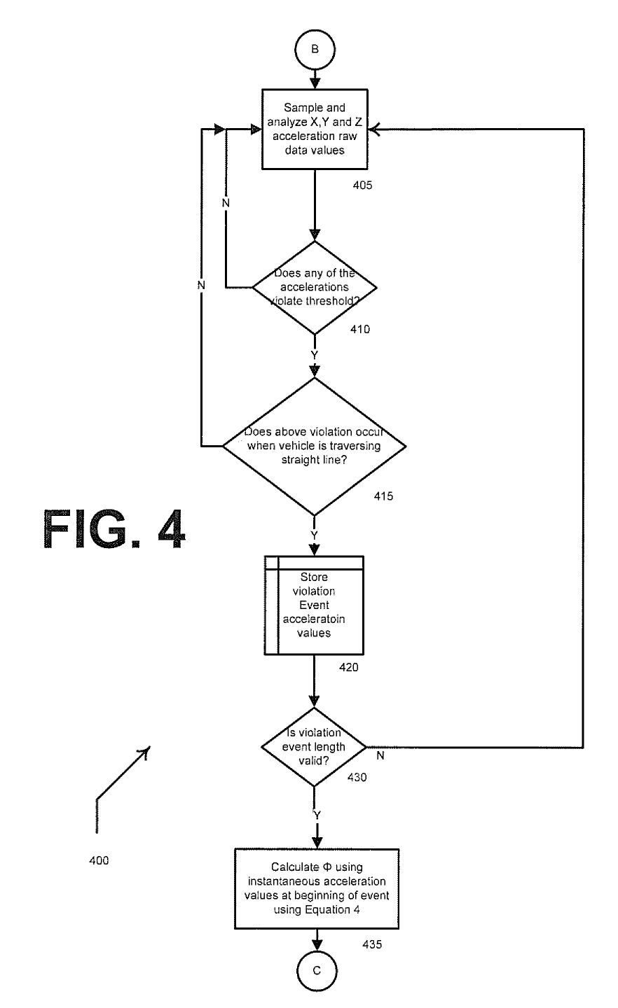

Turning now to FIG. 4, the figure illustrates a flow diagram of method 400 for determining an actual value for first rotation angle φ. After receiving control, method 400 samples data from accelerometer sensors, preferably at the same rate method 300 sampled data at step 325, from accelerometer device 10 shown in FIG. 1, and analyzes each sample of data at step 405. In performing the analysis at step 410, method 400 determines whether the value for each axis (each sensor of the accelerometer) exceeds a threshold corresponding to the axis. Such an exceeding of the threshold may be designated as an ‘operational event’ and is preferably an event caused by longitudinal acceleration of the vehicle, or acceleration along the vehicle's y axis. In practice, only a hard braking event creates enough acceleration to exceed the preferably selected threshold (in the case of brake-caused deceleration of the vehicle acceleration occurs in the −y direction of the reference frame). In an aspect, the threshold for a given axis is a predetermined sum of the mean determined at step 335 and twenty times the is standard deviation determined at step 335, as shown below in equation 4.

threshold=μ_{stationary}+20σ_{stationary} eq.4

At step 410, method 400 determines whether any of the three values from the accelerometer exceed the threshold for the corresponding axis. If the result of step 410 is that the sampled value for each of sensor does not exceed the threshold for the corresponding axis, then method 40-0 returns to step 405. If the sampled value for any of the three accelerometer sensors exceeds the corresponding threshold, method 400 advances to step 415.

At step 415, method 400 determines whether the sampled value exceeded its corresponding threshold while the accelerometer device, or a device that moves with the accelerometer device, was traversing a substantially straight line. Preferably, method 400 determines the path of the accelerometer device, vehicle, or associated mobile wireless device that moves with the vehicle, by querying a GPS circuit for heading information corresponding to the time when the sample acquired at step 405 occurred. Course information may be included in a course signal value retrieved from the GPS circuitry. If route information returned from the GPS circuit indicates that the accelerometer device, vehicle, or associated wireless device was not moving substantially straight (along the y axis of vehicle 8 shown in FIG. 2), method 400 returns to step 405.

If method 400 determines at step 415 that the vehicle, associated device, or accelerometer device was moving substantially straight, method 400 advances to step 420 and stores the sampled data to a memory. Alternatively, rather than storing the actual measured value, method 400 may store a flag corresponding to the sample time stamp to memory.

At step 430, method 400 determines whether the operation al event exceeded is a predetermined length of time. The determination of event length may be based on number of samples consecutively stored at step 420 (for a sample value, or flag, to be stored, it would have had to exceed the threshold at step 410). Alternatively, a predetermined number of samples stored within a predetermined length of time, based on the time stamps of the samples could also be used to determine length. If analysis of stored samples at step 430 does not indicate that an operation event occurred while the accelerometer device, vehicle, or associated wireless device was traversing a substantially straight line, method 400 preferably clears the stored samples stored at successive iterations of 420 before the determination that an operational event did not occur, and returns to step 405.

If, however, the determination at step 430 indicates that an operation at event has occurred because more than a predetermined number of samples analyzed at step 405 exceeded a threshold while the accelerometer device, vehicle, or associated wireless device was traversing a substantially straight line, method 400 advances to step 435. One will appreciate that preferring that a number of sampled acceleration values exceed a threshold of the mean acceleration values for a given accelerometer sensor by twenty times the standard deviation of data acquired from that same sensor eliminates random road events, such as hitting a bump or hole in a roadway from triggering a calculation at step 435.

At step 435, method 400 calculates an actual value of the first rotation angle φ using samples values at the beginning of the operation event. The values used may be the peak value, or an average of a few values around the peak. For purposes of discussion, the single or average values will be referred to as the operational event magnitude.

is At step 435, method 400 expands equation 2 into equation 5, the second equation of which corresponding C_{y}, or the longitudinal acceleration of the car, is shown in equation 6; both eqs. 5 and 6 are given below:

$$\begin{matrix}( \begin{matrix}{C}_{x} \\ {C}_{y} \\ {C}_{z}\end{matrix} ) = [ \begin{matrix}\begin{matrix}{A}_{x} \cdot ( \begin{matrix}\begin{matrix}cos ( ϕ ) \cdot \\ cos ( ψ ) - \\ \begin{matrix}cos ( θ ) \cdot \\ sin ( ϕ ) \cdot \end{matrix}\end{matrix} \\ sin ( ψ )\end{matrix} ) - {A}_{y} \cdot ( \begin{matrix}\begin{matrix}cos ( ϕ ) \cdot \\ sin ( ψ ) + \\ cos ( ψ ) \cdot \\ cos ( θ ) \cdot \end{matrix} \\ sin ( ϕ )\end{matrix} ) + {A}_{z} \cdot sin ( ϕ ) \cdot sin ( θ ) \\ {A}_{x} \cdot ( \begin{matrix}\begin{matrix}cos ( ψ ) \cdot \\ sin ( ϕ ) + \\ \begin{matrix}cos ( ϕ ) \cdot \\ cos ( θ ) \cdot \end{matrix}\end{matrix} \\ sin ( ψ )\end{matrix} ) - {A}_{y} \cdot ( \begin{matrix}\begin{matrix}sin ( ϕ ) \cdot \\ sin ( ψ ) - \\ cos ( ϕ ) \cdot \\ cos ( ψ ) \cdot \end{matrix} \\ cos ( θ )\end{matrix} ) - {A}_{z} \cdot cos ( ϕ ) \cdot sin ( θ )\end{matrix} \\ {A}_{z} \cdot cos ( θ ) + {A}_{y} \cdot cos ( ψ ) \cdot sin ( θ ) + {A}_{x} \cdot sin ( ψ ) \cdot sin ( θ )\end{matrix} ] & eq . 5 \\ {C}_{y} ( ϕ , θ , ψ ) = {A}_{X} ( cos ( ψ ) \cdot sin ( ϕ ) + cos ( ϕ ) \cdot cos ( θ ) \cdot sin ( ψ ) ) - {A}_{Y} ( sin ( ϕ ) \cdot sin ( ψ ) - cos ( ϕ ) \cdot cos ( ψ ) \cdot cos ( θ ) ) - {A}_{z} \cdot cos ( ϕ ) \cdot sin ( θ ) & eq . 6\end{matrix}$$

At step 435, method 400 derives the first derivative of eq. 6 with respect to φ. Then, the first derivative of eq. 6 is set equal to zero and values of second and third angles θ and Ψ previously stored at step 345 shown in FIG. 3 are substituted into the first derivative of eq. 6 shown in equation 7.

$$\frac{d}{d ϕ} {C}_{y} ( ϕ , θ , ψ ) = {A}_{X} \cdot ( cos ( ϕ ) \cdot cos ( ψ ) - cos ( θ ) \cdot sin ( ϕ ) \cdot sin ( ψ ) ) - {A}_{Y} \cdot ( cos ( ϕ ) \cdot sin ( ψ ) + cos ( ψ ) \cdot cos ( θ ) \cdot sin ( ϕ ) ) + {A}_{z} \cdot sin ( ϕ ) \cdot sin ( θ )$$

Solving eq. 7 for φ results in equation 8. Plugging actual values of θ and Ψ into eq. 8 results in an actual value for φ. After performing step 435, method 400 advances to method 500.

$$ϕ := {tan}^{- 1} [ \frac{( {A}_{X} \cdot cos ( ψ ) - {A}_{Y} \cdot sin ( ψ ) )}{( \begin{matrix}{A}_{X} \cdot cos ( θ ) \cdot sin ( ψ ) + \\ {A}_{Y} \cdot cos ( ψ ) cos ( θ ) - {A}_{Z} \cdot sin ( θ )\end{matrix} )} ] \qquad eq . 8$$

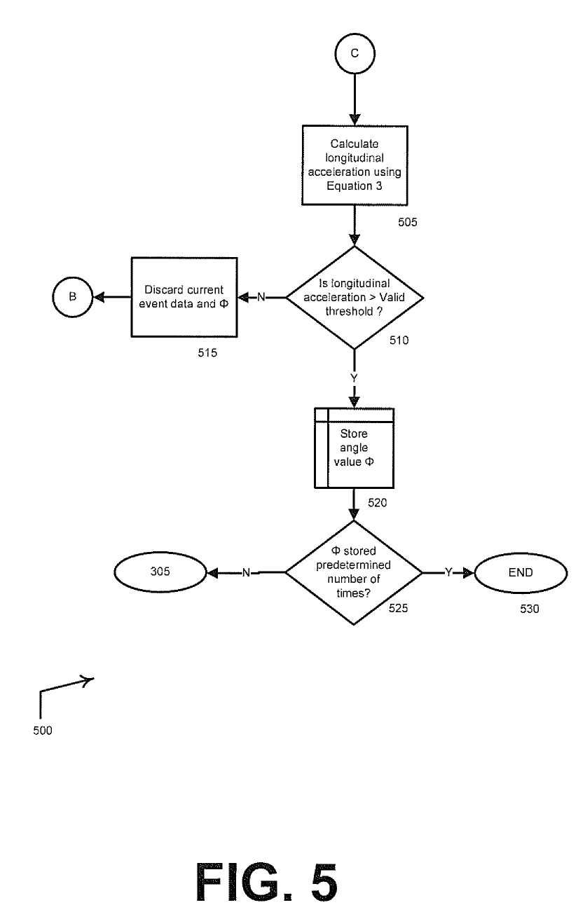

Turning now to FIG. 5, the figure illustrates a flow diagram of a method 500 for determining the acceleration acting on a body having a reference frame based on sensor data acquired and analyzed by an accelerometer device having a referred frame. Method 500 receives Euler's angles passed from method 400 described above. At step 505, method 500 substitutes actual values for φ, θ, and Ψ into eq. 2 and calculates a longitudinal acceleration value C_{y} experienced by vehicle 8 shown in FIG. 1.

Substituting actual values for angles φ, θ, and Ψ results in a three component scaler times a three component scaler on the right hand of the equal sign, the first component being the result of the angle substitution, and the second component being data Aₓ, A_{y}, and A_{z}, received from three sensors of an accelerometer device, such as device 10 shown in FIG. 1. Thus, multiplying the raw data measured from the sensor corresponding to Aₓ by its respective scaler in the first component results in Cₓ, or the acceleration experienced by vehicle 8 along the x axis of the reference frame. Raw data from a given sensor is typically a voltage value representing force acting on the accelerometer device along the sensor's corresponding axis of the referred frame. Similarly, multiplying raw data from sensors corresponding to the y and z axes of the referred frame by their corresponding first component scalers, results in C_{y} and C_{z}, respectively.

Continuing with the description of method 500, at step 510, a determination is made whether the longitudinal acceleration (along the y axis of the reference frame) exceeds a threshold. Unlike the threshold used in method 400 at step 410, which determined that an operational event occurred rather than a random road irregularity, the threshold used at step 510 determines that the operational event (typically braking as discussed above) generated a strong signal—a strong signal tends to provide a good determination of φ at step 435. Continuing with the description of FIG. 5, if the calculated longitudinal acceleration value does not exceed the predetermined threshold, method 500 advances from step 510 to step 515 and discards the value for φ calculated at step 435 before returning to step 305 is described in reference to FIG. 3.

If, however, the longitudinal acceleration value determined at step 505 exceeds the threshold, at step 520 the value for φ is stored to a memory of the accelerometer device, central computer, or associated wireless mobile device, such as a smart phone. At step 535, method 500 determines whether φ has been calculated a predetermined number of times and stored to a memory device. Since the first rotation angle φ is the last angle determined, counting the number of times φ has been stored indicates that the other two rotation angles have also been stored the same number of times. For each rotation angle, an average of a current value thereof and a previous average is stored as the new current value at step 520 and a counter is incremented to reflect the number of times the three rotation angles have been calculated and stored. The predetermined number of times for performing method 300, 400, and 500 may vary, but preferably is three times following initial fixing of an accelerometer device 10 to a vehicle 8, as shown in reference to FIG. 1, or following the resetting of stored values for the three actual rotation angles if a correlation check fails a predetermined number of times as described elsewhere herein. If the determination at step 525 is that the predetermined number of times of storing angle φ equals the predetermined number, the method 500 ends at step 530. If the determination at step 525 is that φ has not been stored a predetermined number of times, control returns to step 305 shown in FIG. 3, and calculation of the three rotation angles repeats.

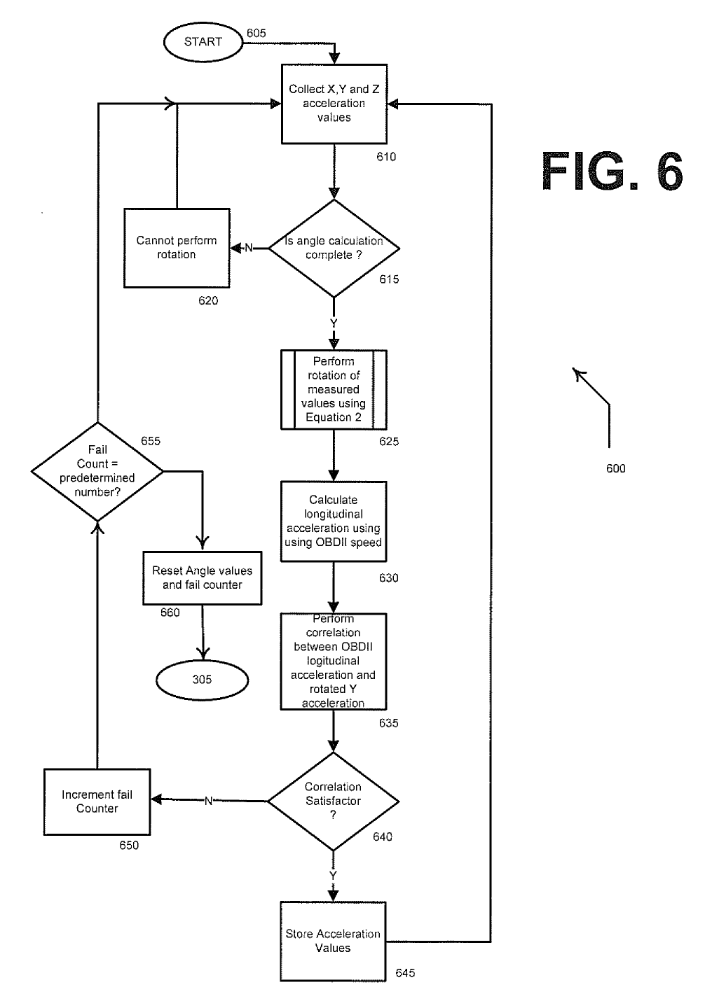

Turning now to FIG. 6, a flow diagram of a method 600 for determining whether calculated rotation angles remain valid for transforming acceleration values measured with an accelerometer device having a referred coordinate frame into acceleration values experienced in a reference frame by a vehicle to which the accelerometer device is fixed. Previously calculated rotation angles may not remain valid for a variety of reasons, with the primary reason being that the acceleration device has been reoriented with respect to the vehicle since the angles were calculated and stored.

Method 600 begins at step 605. At step 610, the method causes the processor which has been configured to run the methods described herein, including method 600, to sample data received from accelerometer sensors, typically at the same rate used for other sampling operations described herein. At step 615, the processor determines that the angle calculation and determination steps have been performed the predetermined number of times as described above. If the rotation angles have not been finally determined as described above, method 600 determines at step 620 that it cannot transform measured values into the vehicle reference frame and control returns to step 610. It will be appreciated that method 600 should not have been reached if the rotation angles had not already been determined, but steps 615 and 620 may be performed as a error handling check in case the previously stored values for rotation angles have been corrupted.

In addition, it will be appreciated that steps 615 and 620 may be performed periodically at a frequency much slower than the rest of method 600 executes. For example, steps 615 and steps 620 may be performed before step the sampling step described in reference to step 610, and then steps 615 and 620 may not be performed again for fifteen minutes, or some other predetermined period.

If the determination at step 615 is that rotation angles have been calculated and stored a predetermined number if times, method 600 advances to step 625 and instruct the processor running the method to transform measured acceleration values from the referred frame to the reference frame as described above in reference to eq. 2. At step 630, the processor running method 600 also retrieves vehicle speed information present at the vehicle's OBD-II connector, or equivalent, to determine longitudinal acceleration based on changes in the vehicle's speed. Preferably, the calculation at step 630 is made according to eq. 8, where x′ is OBD a longitudinal acceleration series, y′ is longitudinal Acceleration series from accelerometer Y axis after rotation, μₓ is mean of series x′, and μ_{y} is mean of series y′.

$$Corr ( {x}^{′} , {y}^{′} ) = \frac{{\sum }_{i = 0}^{N} [ ( x ( i ) - {μ}_{x} ) ( y ( i ) - {μ}_{y} ) ]}{\sqrt{{\sum }_{i = 0}^{N} {( x ( i ) - {μ}_{x} )}^{2}} \cdot \sqrt{{\sum }_{i = 0}^{N} {( y ( i ) - {μ}_{y} )}^{2}}}$$

Typically, vehicle speed data made available by the vehicle at the OBD-II connector, is not updated as often as data sampled at step 610 from accelerometer sensors. Thus, a delay of acceleration data analyzed at step 625 may be delayed a predetermined amount of time that estimates a delay between data acquired at step 610 and data retrieved from the vehicle at step 630. Or, time stamps based on a clock of the accelerometer device and a clock of the vehicle may be synchronized and used to align acceleration values determined from OBD-II data with data read from the accelerometer sensors. After a data set of acceleration data calculated from the accelerometer sensor data has been aligned with a data set of acceleration data obtained from the vehicle's OBD-II connector, or equivalent, method 600 performs a correlation between the two data sets at step 635. At step 640, a determination is made whether the correlation exceeds a predetermined correlation value. Preferably, a correlation value of 0.65 is used. Thus, if the correlation value calculated from step 635 exceeds 0.65, method 600 advances to step 645, stores the acceleration values determined at step 625 to a memory, and returns to step 610 and samples data from accelerometer sensors again at step 610. After performing steps 610 through 645 a predetermined period, such as the preferable fifteen minute period for determining if angle calculations have been completed described in reference to steps 615 and 620, accelerometer device 10 shown in FIG. 1, or other wireless device associated with device 10, may wirelessly upload acceleration data stored at each iteration of step 645 to a central computer for further analysis in relation to vehicle 8.

Returning to step 640, of the determination is that the correlation value is less than the predetermined value, a fail counter increments at step 650. At step 655, a determination is made whether the fail counter equals a predetermined value. If the fail counter has not reached the predetermined value, method 600 returns to step 610 and continues to sample accelerometer sensor data. If the determination at step 655 is that the fail counter equals the predetermined value, the values stored for fail counter and the rotation angles reset at step 660, and method 600 returns control of the processor in the accelerometer device to step 305 of method 300, which operates as described above in reference to FIG. 3.

These and many other objects and advantages will be readily apparent to one s skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for automatically aligning three accelerometer axes corresponding to an accelerometer device coordinate frame with three vehicle axes corresponding to a coordinate frame of a vehicle, comprising:
determining second and third rotation angles;
retrieving a course signal value from a positioning circuit associated with the accelerometer device; and
determining a first rotation angle when the course signal value indicates that the vehicle is traveling approximately in a straight line.

2. The method of claim 1 further comprising determining that the vehicle is stationary before determining the second and third rotation angles.

3. The method of claim 1 wherein the step of determining the second and third rotation angles includes processing acceleration signal values measured from the accelerometer device along the axes of the accelerometer coordinate frame such that processing the accelerometer signal values corresponding to the x and y axes of the accelerometer coordinate frame with the rotation angles generates a resultant of zero acceleration along of the x and y axes of the vehicle coordinate frame, and wherein an accelerometer signal value corresponding to the z axis of the accelerometer coordinate frame indicates acceleration equal to acceleration due to gravity for the z axis of the vehicle coordinate frame.

4. The method of claim 1 further comprising:
determining the three rotation angles a predetermined number of times, and storing to a memory device for each rotation angle an average of a current value thereof and a previous average corresponding to each of the given rotation angles.

5. The method of claim 4, further comprising:
retrieving the stored average angle values from the memory device; and
applying the average angle values to the signal values corresponding to each of the respective accelerometer axes of the accelerometer device coordinate frame to transform each of the three acceleration signal values to acceleration values is experienced by the vehicle along the respective three axes of the vehicle coordinate frame.

6. The method of claim 1 wherein the step of determining second and third rotation angles include determining first, second, and third Euler's rotation equations to transform coordinates in the accelerometer coordinate frame to the vehicle coordinate frame.

7. The method of claim 6 wherein the step of determining the first rotation angle includes determining the first derivative of the second Euler's rotation equation with respect to the first rotation angle, setting the first derivative of the second Euler's rotation equation with respect to the first rotation angle equal to zero, and solving for the first rotation angle using the already determined first and second rotation angles, and an accelerometer signal value corresponding to each of the axes of the accelerometer coordinate frame.

8. The method of claim 1 wherein further comprising:
sampling data from an onboard diagnostic information system signal indicative of the vehicle's speed;
determining a derived acceleration value representing the vehicle's acceleration from the sampled data indicative of the vehicle's speed;
processing accelerometer signal values corresponding to a y axis of the accelerometer device coordinate frame with the rotation angles to generate a measured longitudinal acceleration value of the vehicle;
comparing the derived acceleration value with the measured longitudinal acceleration value; and
repeating the steps of claim 1 if the derived acceleration value and the measured longitudinal acceleration value differ more than a predetermined amount.

9. The method of claim 8 wherein the comparison step includes performing a correlation function using the derived acceleration value and measured longitudinal acceleration value.

10. The method of claim 7 wherein the first rotation angle is determined after detection of an operational event.

11. An accelerometer device configured to perform a method for automatically aligning three accelerometer axes corresponding to an accelerometer device coordinate frame with three vehicle axes corresponding to a coordinate frame of a vehicle, the steps of the method comprising:
determining second and third rotation angles;
retrieving a course signal value from a positioning circuit associated with the accelerometer device; and
determining a first rotation angle when the course signal value indicates that the vehicle is traveling approximately in a straight line.

12. The accelerometer device of claim 11 wherein the method further comprises determining that the vehicle is stationary before determining the second and third rotation angles.

13. The accelerometer device of claim 11 wherein the step of determining the second and third rotation angles includes processing acceleration signal values measured from the accelerometer device along the axes of the accelerometer coordinate frame such that processing the accelerometer signal values corresponding to the x and y axes of the accelerometer coordinate frame with the rotation angles generates a resultant of zero acceleration along of the x and y axes of the vehicle coordinate frame, and wherein an accelerometer signal value corresponding to the z axis of the accelerometer coordinate frame indicates acceleration equal to acceleration due to gravity for the z axis of the vehicle coordinate frame.

14. The accelerometer device of claim 11 wherein the method further comprises:
determining the three rotation angles a predetermined number of times, and storing to a memory device for each rotation angle an average of a current value thereof and a previous average corresponding to each of the given rotation angles.

15. The accelerometer device of claim 14 wherein the method further comprises:
retrieving the stored average angle values from the memory device; and
applying the average angle values to the signal values corresponding to each of the respective accelerometer axes of the accelerometer device coordinate frame to transform each of the three acceleration signal values to acceleration values experienced by the vehicle along the respective three axes of the vehicle coordinate frame.

16. The accelerometer device of claim 11 wherein the step of determining second and third rotation angles include determining first, second, and third Euler's rotation equations to transform coordinates in the accelerometer coordinate frame to the vehicle coordinate frame.

17. The accelerometer device of claim 16 wherein the step of determining the first rotation angle includes determining the first derivative of the second Euler's rotation equation with respect to the first rotation angle, setting the first derivative of the second Euler's rotation equation with respect to the first rotation angle equal to zero, and solving for the first rotation angle using the already determined first and second rotation angles, and an accelerometer signal value corresponding to each of the axes of the accelerometer coordinate frame.

18. The accelerometer device of claim 11 wherein the method further comprises:
sampling data from an onboard diagnostic information system signal indicative of the vehicle's speed;
determining a derived acceleration value representing the vehicle's acceleration from the sampled data indicative of the vehicle's speed;
processing accelerometer signal values corresponding to a y axis of the accelerometer device coordinate frame with the rotation angles to generate a measured longitudinal acceleration value of the vehicle;
comparing the derived acceleration value with the measured longitudinal acceleration value; and
repeating the steps of the method of claim 11 if the derived acceleration value and the measured longitudinal acceleration value differ more than a predetermined amount.

19. The accelerometer device of claim 18 wherein the comparison step includes performing a correlation function using the derived acceleration value and measured longitudinal acceleration value.

20. The accelerometer device of claim 17 wherein the first rotation angle is determined after detection of an operational event.
